(19) United States
(12) Patent Application Publication
(10) Pub. No.: US 2014/0012748 A1
(43) Pub. Date: Jan. 9, 2014

(54) REPAIR SYSTEM AND METHOD

(71) Applicant: GENERAL ELECTRIC COMPANY, SCHENECTADY, NY (US)

(72) Inventors: MARK EDWARD KNAPP, ATLANTA, GA (US); JUSTIN GILLAM, OXFORD, MI (US)

(21) Appl. No.: 13/929,918

(22) Filed: Jun. 28, 2013

Related U.S. Application Data
(60) Provisional application No. 61/668,180, filed on Jul. 5, 2012.

(51) Int. Cl. G06Q 10/00

(52) U.S. Cl. CPC G06Q 10/20
USPC 705/40; 235/376

(57) ABSTRACT

Systems and methods of the invention relate to utilizing an indicia for a part to identify a repair code related to a repair. Embodiments of the present invention include an identify component that corresponds the indicia to a repair code with a Car Repair Billing (CRB), wherein the indicia is linked to a repair code to a part by a link component. The part and included indicia can be utilized to identify at least one repair code for the part rather than manually identifying a related repair code for the part.

### CROSS-REFERENCE TO RELATED APPLICATIONS

This application claims the benefit of U.S. Provisional Application Ser. No. 61/668,180, filed Jul. 5, 2012, and entitled “REPAIR SYSTEM AND METHOD.” The entirety of the aforementioned application is incorporated herein by reference.

### BACKGROUND

1. Technical Field

Embodiments of the subject matter disclosed herein relate to a vehicle repair billing system and management thereof.

2. Discussion of Art

Repair facilities often utilize Car Repair Billing (CRB), which is a computer-implemented system that facilitates reporting and/or invoicing railroads, car owners, client asset owners, vehicle owners, lessee, and lessor, among others. There can be a large number of standardized repair codes that correspond to specific repairs at a repair facility. Moreover, each repair can include various parts.

It may be desirable to have a system and method for repair systems that differ from those that are currently available.

### BRIEF DESCRIPTION

In one embodiment, a method is provided. The method includes establishing an association between a part and an indicia (e.g., the step comprises associating the part to the indicia), and generating at least one repair code for the part based at least on the association.

In another embodiment, the method further includes associating the indicia to the part for a vehicle. Furthermore, alternatively or additionally, the indicia can be associated with a plurality of parts such that the repair code is generated based on at least one of a read or a scan of any one of the plurality of parts. The method further includes repairing at least one part associated with the repair code in response to at least one of a read or a scan of the indicia, or replacing at least one part associated with the repair code in response to at least one of a read or a scan of the indicia.

In one embodiment, a system is provided that includes a first component configured to create an indicia for a part, a second component configured to link the part with a repair code from a Car Repair Billing (CRB), a device configured to identify the indicia for the part, and a third component configured to identify the repair code for the part based upon the indicia.

In one embodiment, a system is provided that includes means for creating an indicia for a part, means for linking the part with a repair code from a Car Repair Billing (CRB), means for identifying the indicia for the part, means for identifying the repair code for the part based upon the indicia, and means for utilizing the repair code to update at least one of an inventory or an invoice.

In another embodiment, a system comprises a communication module, a scheduling module operably coupled with the communication module, and a billing module operably coupled with the scheduling module. The communication module is configured to receive information relating to a first part. The information is generated at least in part from at least one of a scan or a read of an indicia associated with the first part. The scheduling module is configured to automatically schedule, based on the information, one or more of: delivery of a replacement part to replace the first part; one or more actions relating to a repair of the first part or a repair of a vehicle associated with the first part; or training relating to at least one of the first part, repair of the first part, or repair of the vehicle. The billing module is configured to automatically generate, based on at least one of the information or the schedule, billing data for at least one of the first part, the replacement part, the repair of the first part, the repair of the vehicle, or the training.

### BRIEF DESCRIPTION OF THE DRAWINGS

Reference is made to the accompanying drawings in which particular embodiments are illustrated as described in more detail in the description below, in which:

FIG. 1 is an illustration of an embodiment of a system for generating a repair code for a part based upon identification of an indicia;

FIG. 2 is an illustration of an embodiment of a system for managing an inventory and/or invoicing based upon an indicia for a part;

FIG. 3 is an illustration of an embodiment of a system for creating an indicia for a part utilized with a repair represented by a repair code in Car Repair Billing (CRB);

FIG. 4 illustrates a flow chart of an embodiment of a method for creating an indicia for a part utilized with a repair represented by a repair code;

FIG. 5 illustrates a flow chart of an embodiment of a method for managing an inventory and/or invoicing based upon an indicia for a part;

FIG. 6 illustrates a screenshot in accordance with the subject invention;

FIG. 7 illustrates a screenshot in accordance with the subject invention;

FIG. 8 illustrates a screenshot in accordance with the subject invention;

FIG. 9 illustrates a screenshot in accordance with the subject invention;

FIG. 10 illustrates a screenshot in accordance with the subject invention;

FIG. 11 illustrates a screenshot in accordance with the subject invention; and

FIG. 12 is an illustration of a system, according to another embodiment of the invention.

### DETAILED DESCRIPTION

Embodiments of the invention relate to methods and systems for utilizing an indicia for a part to identify a repair code related to a repair. The repair code can correspond to a repair code with a Car Repair Billing (CRB), wherein the indicia links a repair code to a part. The part and included indicia can be utilized to automatically identify at least one repair code for the part rather than manually identifying a related repair code for the part. In another embodiment, the invention relates to methods and/or systems for creating an indicia for a part as well as linking the part to a particular repair code. The indicia can be further employed with managing inventory, invoices, among others.

With reference to the drawings, like reference numerals designate identical or corresponding parts throughout the several views. However, the inclusion of like elements in different views does not mean a given embodiment necessarily includes such elements or that all embodiments of the invention include such elements.

The term “client asset” as used herein means a fixed asset or a mobile asset that is owned and/or operated by a client entity such as, for example, a railroad, a power generation company, a shipping company (e.g., land, sea, air, and/or a combination thereof), a mining equipment company, an airline, or other asset-owning and/or asset-operating entity. The term “vehicle” as used herein can be defined as an asset that is a mobile machine that transports at least one of a person, people, or a cargo. For instance, a vehicle can be, but is not limited to being, a rail car, an intermodal container, a locomotive, a marine vessel, a mining equipment, an industrial equipment, a construction equipment, and the like.

The term “repair facility” as used herein can be defined as a location that evaluates and/or performs a repair on a vehicle or other client asset. The terms “Car Repair Billing” and “CRB” as used herein can be defined as a computer-implemented system with a portion of software, a portion of hardware, or a combination thereof that facilitates reporting and/or invoicing railroads, car owners, client asset owners, vehicle owners, lessee, lessor, among others. CRB includes Association of American Railroads (AAR) as well as contract billing, and other suitable billing for railroads. The term “inventory” as used herein can be defined as a tracking of an amount of a part for a vehicle or other client asset, e.g., tracking an amount of plural instances of the part that are kept in reserve for future repairs. The term “purchase order” as used herein can be defined as an instruction to purchase, trade, receive, or sell at least one of a vehicle or other client asset, or a part of a vehicle or other client asset. The term “part” as used herein can be defined as a portion of a vehicle or other client asset, wherein the “part” is involved in a repair for the vehicle or other client asset. Component’ as used herein includes, but is not limited to: any programmed, programmable, or other electronic device or portion thereof that can store, retrieve, and/or process data; one or more computer readable and/or executable instructions, stored on non-transitory computer-readable medium/media, that cause an electronic device to perform one or more functions, actions, and/or behave in a desired manner as specified in the instructions; or combinations thereof.

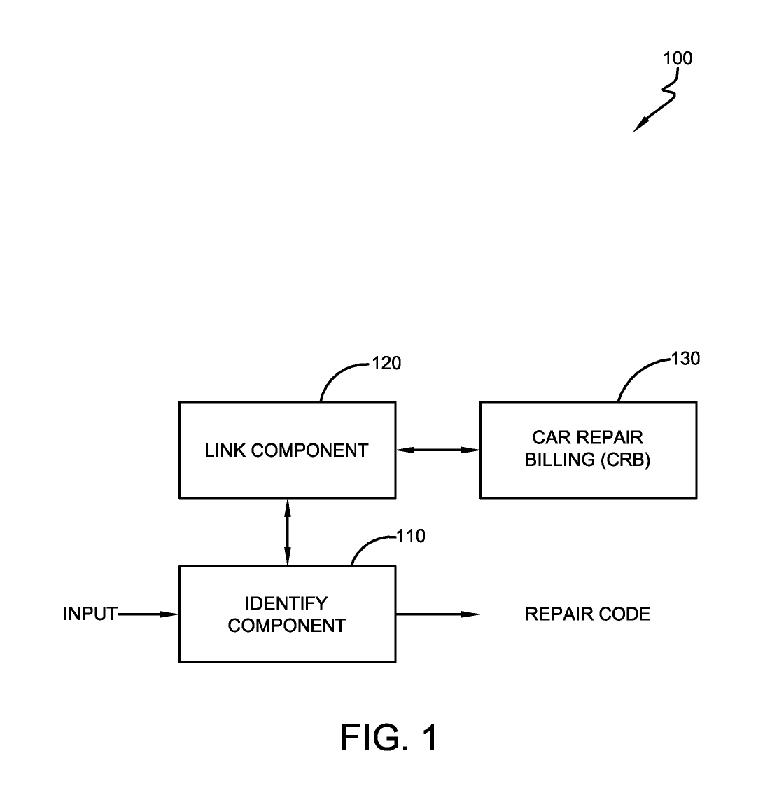

FIG. 1 is an illustration of an embodiment of a system 100 for generating a repair code for a part based upon identification of an indicia. The system can include an identify component 110 that can be configured to analyze and/or ascertain an input, wherein the input can be indicia. In an embodiment, the system allows for a creation of indicia for a part. In another embodiment, alternatively or additionally, the system provides identification and analysis of received indicia. The system can further include a link component 120 that can be configured to link a repair code to a part and/or an identified part. The link component can utilize a CRB to identify a repair code to the part and/or to link the part with a repair code. In one embodiment, the repair code in CRB is utilized for the part for consistency.

For example, the identify component can create an indicia for a part such that the indicia represents the part as well as a linked repair code. Following such example, the identify component can receive a part as an input, wherein the input is a representation of the part (e.g., a model number, a part number, an existing barcode, a unique number(s), among others). This input can further be linked to a repair code via the link component. For instance, the link component can leverage a Car Repair Billing (CRB) 130 to locate a repair code for a particular part.

In another example, the identify component can identify an indicia and generate a corresponding repair code for such part. Thus, a part can include an indicia that is linked to at least one repair code that is utilized by the CRB. Such identification of the indicia alleviates a need for memorization of the vast and numerous repair code(s) associated with each part within a repair facility.

The system can utilize indicia to correspond to at least one repair code for each part. In another example, the indicia can correspond to two or more repair codes for a part. The identify component and the link component can define a suitable number set of repair(s) to an indicia for a part. For example, an indicia for a part can correspond to a repair code and subsequently a repair involving the part. In another example, indicia for a part can correspond to two or more repair codes and subsequently two or more repairs involving the part. For instance, the link component can further be configured to associate the indicia with a plurality of parts such that the repair code is generated based on at least one of a read or a scan of at least one of the plurality of parts.

In another embodiment, the indicia can be assigned in a single instance creating a unique pairing, wherein the unique indicia is particular to a specific part and each part within a repair facility has a unique indicia. For instance, each part within a repair facility can include a unique serial number. In another example, a group of parts can share an indicia (e.g., a repair facility has five (5) of part A and each of the five part A's share an indicia representative of that type of part).

The system can be utilized with a suitable CRB as well as a suitable repair facility that employs CRB. In another example, the system can be implemented with a repair facility that utilizes a suitable billing related to AAR, contract billing, and/or a suitable combination thereof. The identify component and/or the link component can be separate components (as illustrated), incorporated into the CRB, and/or a suitable combination thereof.

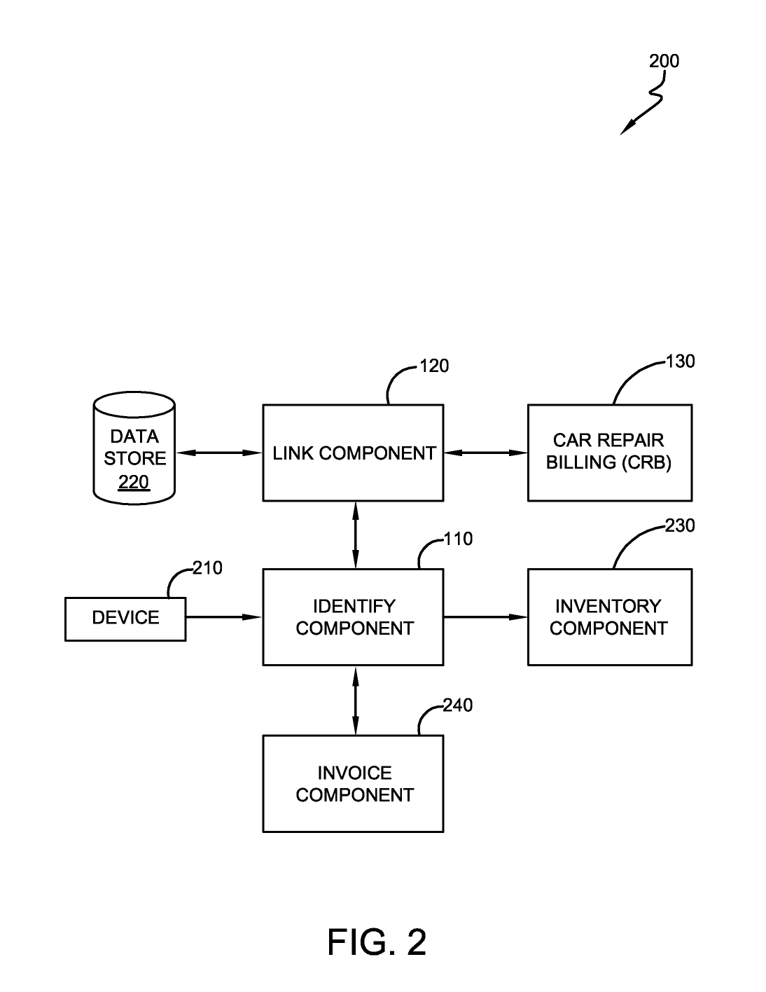

FIG. 2 is an illustration of an embodiment of a system 200 for managing an inventory and/or invoicing based upon indicia for a part. The system can include the identify component that identifies an indicia for a part that is linked to a repair code, wherein the link component links the part to the repair code. In other words, the link component can associate a repair code to a part and incorporate such association in an indicia. The repair code can be based upon CRB. The indicia can be utilized to identify at least one repair code representative of a repair involving the part.

The system can further include a device 210 that can be configured to input data, wherein the data can be, but is not limited to being, a representation or other information of a part (e.g., model number, part number, existing barcode, barcode, and the like), an indicia, or the like. By way of example and not limitation, the device can be a scanner, a barcode reader, a touchscreen, a camera, a smartphone, a laptop, a computer, a portable computing device, a portable scanner, a mobile device, a portable digital assistant (PDA), a tablet, a web camera, among others. In an embodiment, the device 210 can provide a part to be registered with indicia (e.g., creation of an indicia for representation of the part and a repair code). In another embodiment, alternatively or additionally, the device 210 can receive and/or identify indicia for a part.

The identify component can generate and/or identify a repair code associated with an indicia (the indicia identified by the device) based upon the link created by the link component. In one embodiment, the link component stores information related to a link between a part and a repair code in a data store 220. The data store can include relationship information such as, but not limited to, an indicia to a part, a part to a repair code, an indicia to a repair code, CRB information (e.g., repair codes, among others), billing information (price, repair codes, among others), and/or a suitable combination thereof.

The data store can be, for example, either volatile memory or nonvolatile memory, or can include both volatile and nonvolatile memory. The data store of the subject systems and methods is intended to comprise, without being limited to, these and other suitable types of memory. In addition, the data store can be a server, a database, a hard drive, a pen drive, an external hard drive, a portable hard drive, a cloud-based storage, and/or the like.

The system can further include an inventory component 230 that is configured to manage an inventory based upon the indicia for at least one part. The management of the inventory can be a real-time management for updating quantities for at least one part based upon the indicia. An identification of a particular indicia can correspond to a repair code and, in turn, a repair that affects the inventory. For instance, an indicia may translate into a repair (via the linked repair code) and a use of a number (quantity) of a first part and a number (quantity) of a second part, wherein such number of the first part and the number of the second part can be utilized to update an inventory that includes the first part and/or the second part. In another example, the inventory can be updated to reflect incoming part(s) from a repair (via the indicia corresponding to a repair code). Thus, indicia can correspond to a repair code and, in turn, a repair that includes the part. Based on the indicia being identified, the inventory component can update the inventory to reflect an update to a number (quantity) of the part based on the part being removed for the repair. In other words, repairs include incoming parts (incoming to the asset being repaired and thus reducing inventory) and outgoing parts (outgoing from the asset being repaired and thus increasing inventory). The inventory component can be a separate component (as illustrated), incorporated into the identify component, incorporated into the CRB (not shown), and/or a suitable combination thereof.

In another embodiment, the inventory component can be configured to generate a purchase order based at least in part upon an identified indicia for a part. In other words, the detection of indicia can correspond to a repair code and, in turn, a repair being made in which a purchase order can be generated. For instance, the purchase order can be for a new part, a new reconditioned part, a request for a reconditioning of a part, a request for an exchange of an old part (e.g., removed during a repair) for another part (e.g., reconditioned, new, and the like), among others.

The system can further include an invoice component 240 that can be configured to generate an invoice (e.g., a statement, a bill, a receipt, among others). The invoice can include details of a repair such as the repair code(s) associated with the indicia of the part. For instance, the repair code(s) can be included in the generated invoice to provide details on work performed to request payment to a responsible party (e.g., owner, lessor, lessee, among others). For instance, the invoice can include at least one of a price, at least one repair code, and/or data related to at least one part. The invoice component can be a separate component (as illustrated), incorporated into the identify component, incorporated into the CRB (not shown), and/or a suitable combination thereof.

In another example, the system can close out a repair order based on a detection of indicia for a part. For instance, the system can receive a repair order at a repair facility, wherein the indicia for at least one part for the repair order is identified by at least one of the identify component and/or the device based on at least one of a scanning or a reading of the indicia. Based upon the identification of the indicia (e.g., scanning, reading, among others), the repair order can be closed or removed from the system. The system further includes initiating the repairing of at least one part associated with the repair code in response to at least one of a read or a scan of the indicia. The system further includes initiating the replacing of at least one part associated with the repair code in response to at least one of a read or a scan of the indicia. Additionally, the system can provide the repair code being one of a plurality of repair codes and each of the plurality of repair codes is associated with a single repair or a defined set of discrete repairs.

By way of example and not limitation, the following can be repair codes and corresponding repairs in accordance with the subject invention:

| Repair | |
|---|---|
| Code | Repair Description |
| 1840 | BRAKE SHOE-COMP, HI-FRCT 2 IN. |
| 1838 | BRAKE SHOE-COMP. HI-FRCT 1-½ IN. |
| 4204 | CARBON STEEL, STRUCTURAL, PRESSED |
| 1165 | AIR HOSE SUPPORT-COMPLETE |
| 4410 | BOLT, HT, ⅝ IN.DIA.OR LESS UNDER 6″ LONG |
| 4404 | BOLT, COMMON STANDARD |
| 3778 | PEDESTAL ROOF LINER, CLIP ON TYPE |
| 1628 | AIR BRAKE HOSE-AAR APPROVED STANDARD |
| | COUPLING |
| 4400 | COTTER OR SPLIT KEY |
| 4422 | TWO-PIECE RIVET, NON-COATED ⅝ INCH DIA OR |
| | OVER |
| 1843 | BRK SHOE-COMP-HI-FRCT 2 IRON INS (RED) |
| 2076 | COUPLER KNUCKLE PIN, METALLIC |
| 5500 | REFLECTIVE SHEETING, INITIAL APPLICATION OR |
| | RENEW |
| 3336 | NEW WHL SET 36 IN, 1-W 6 ½ × 12 AXLE |
| 1852 | BRAKE SHOE KEY |
| 4414 | BOLT, HT, 3/4″ DIA.OR OVER, UNDER 6″ LONG |
| 3774 | TRUCK SIDE/BOLSTER FRICTION CAST WEAR PLATE- |
| | STABIL |
| 1696 | METALLIC BRAKE BEAM WEAR LINER |
| 4580 | HAND HOLD OR GRAB IRON 36 INCH OR LESS |
| 2480 | UNCOUPLING LEVER NON-TELESCOPING |
| 3337 | TURNED WHEEL SET 36 IN, 6 ½ × 12 AXLE |
| 4342 | STANDARD TEMPERATURE AEI TAG, AT5118-AAR |
| 4418 | TWO-PIECE RIVET, NON-COATED LESS THAN ⅝ INCH |
| | DIA |
| 3584 | TRUCK STABILIZED FRICTION CASTING STABILIZED |
| | TRUCK |
| 2054 | KNUCKLE E50HTE, E50AE, E50ARE OR E50BE |

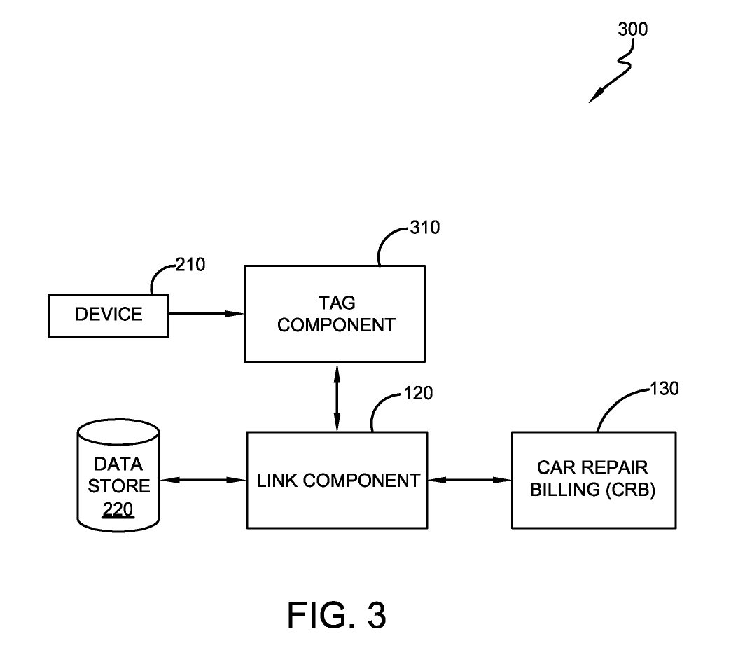

FIG. 3 is an illustration of an embodiment of a system 300 for creating indicia for a part utilized with a repair represented by a repair code in Car Repair Billing (CRB) 130. The system 300 includes the device that can input data such as, but not limited to, identification of a part, a portion of data representative of a part, and/or a suitable combination thereof. A tag component 310 can be configured to generate an indicia for the part (identified by the device), wherein the indicia can be, but is not limited to, a barcode, a 2-Dimensional (2D) barcode, a 3-Dimensional (3D) barcode, a Quick Response (QR) code, an unpowered near field communication (NFC) tag, a radio-frequency identification (RFID) chip, an RFID tag, a model number of the part, a serial number of the part, an existing barcode for the part, among others.

The link component can further utilize the indicia created by the tag component to associate a repair code to the indicia and, in turn, the part. As discussed, the link component can leverage the CRB to generate a relationship for indicia for a part and a corresponding repair code. Furthermore, the data store can store the relationships between the parts, the one or more indicia, the repair codes, among others.

The aforementioned systems, components, (e.g., identify component, link component, device, inventory component, invoice component, among others), and the like have been described with respect to interaction between several components and/or elements. Such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein for the sake of brevity, but known by those of skill in the art.

While for purposes of simplicity of explanation, the methodologies are shown and described as a series of blocks, the claimed subject matter is not limited by the order of the blocks, as some blocks may occur in different orders and/or concurrently with other blocks from what is depicted and described herein. Moreover, not all illustrated blocks may be required to implement the methods described hereinafter.

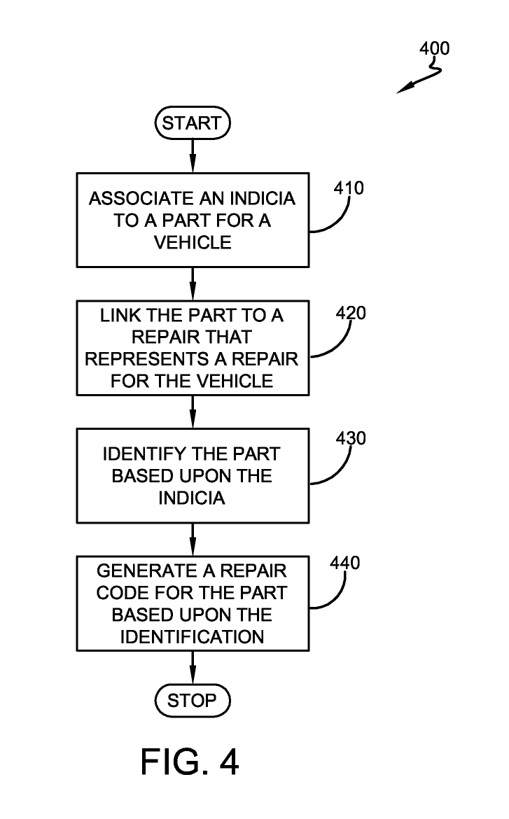

FIG. 4 illustrates a flow chart of a method 400 for creating an indicia for a part utilized with a repair represented by a repair code. At reference numeral 410, indicia can be associated to a part for a vehicle. At reference numeral 420, the part can be linked to a repair code, wherein the repair code can represent a repair for a vehicle. At reference numeral 430, the part can be identified based upon indicia. At reference numeral 440, a repair code can be generated for the part based at least upon the identification.

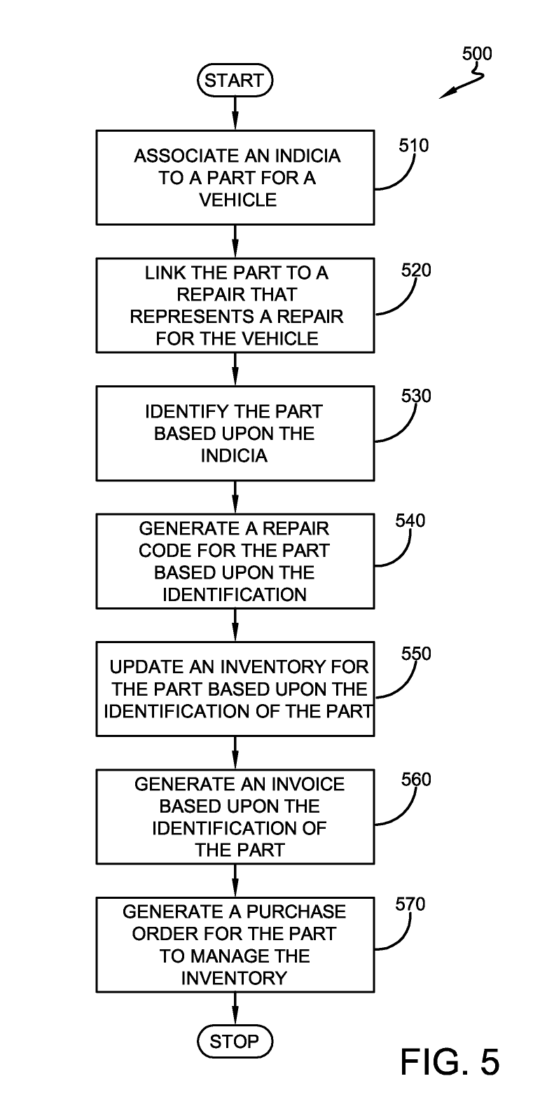

FIG. 5 illustrates a flow chart of a method 500 for managing an inventory and/or invoicing based upon an indicia for a part. At reference numeral 510, indicia can be associated to a part for a vehicle. At reference numeral 520, the part can be linked to the repair code, wherein the repair code can represent a repair for a vehicle. At reference numeral 530, the part can be identified based upon an indicia. At reference numeral 540, a repair code can be generated for the part based at least upon the identification.

At reference numeral 550, an inventory can be updated for the part based upon the identification of the part. At reference numeral 560, an invoice can be generated based upon the repair code. The invoice can include a billing that includes at least the repair code representing the completed repair based upon the indicia being identified. At reference numeral 570, a purchase order can be generated for the part to increase an inventory. The purchase order can include an order request for an additional part or parts based upon the identified indicia. In another embodiment, the purchase order can include an order request to reduce or cancel a part or parts based upon the identified indicia.

The method can further include associating the indicia with a plurality of parts such that the repair code is generated based on at least one of a read or a scan at least one of the plurality of parts. The method can further include receiving a repair order at a repair facility, identifying the indicia for at least one part for the repair order based on at least one of a scanning or a reading of the indicia, and/or closing the repair order upon the identification of the at least one part for the repair order (e.g., an identification of detection of an indicia can be by reading or scanning). The method further includes repairing at least one part associated with the repair code in response to at least one of a read or a scan of the indicia, and/or replacing at least one part associated with the repair code in response to at least one of a read or a scan of the indicia. Additionally, the method can provide the repair code being one of a plurality of repair codes and each of the plurality of repair codes is associated with a single repair or a defined set of discrete repairs.

The following is an exemplary employment of the systems and methods described above and is solely for illustrative purposes. Utilizing indicia for a part to identify a repair code related to a repair facilitates adding repairs to a facility. The indicia of a part is scanned, a field or two entered by the user, and the repairs are automatically added. The system automatically allocates the correct parts, generates the correct prices, and is ready to scan the next indicia. The system can specify which repairs get added when an indicia is scanned for a part, add repairs by scanning indicia with the device, and/or print part indicia onto labels to affix onto the parts or reference books (for instance).

Indicia and repairs can have a relationship. An indicia can correspond to repairs and such repairs can be added when a part indicia is scanned. This enables the system to automatically create the repairs and allocate the inventory parts when an indicia is scanned. This relationship between the indicia and the repairs is maintained by, for instance, a customer's administrative user.

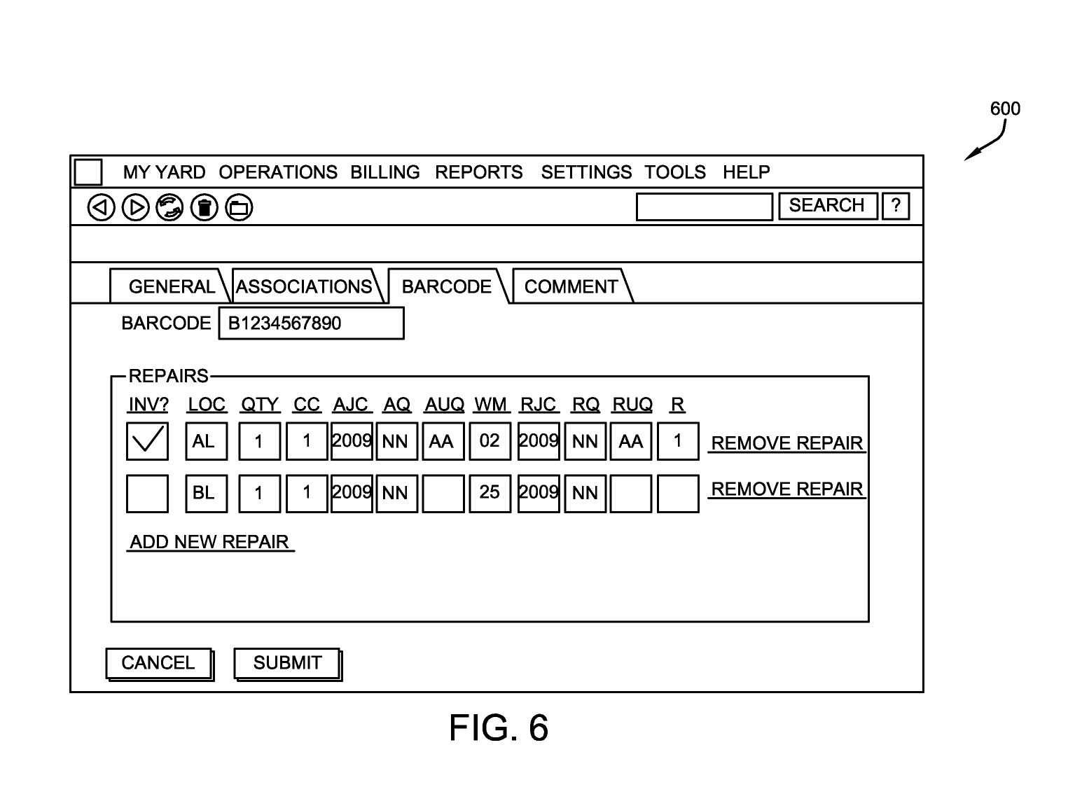

In an embodiment, the subject disclosure can provide editing of a part. The part can be edited by specifying indicia and specifying repairs to add when the part's indicia is scanned. The indicia and the repairs that are added when this indicia is scanned are specified on a new indicia tab when editing an inventory part. See FIG. 6 and screenshot 600 as an example. The “Inv?” column is used to indicate which repair the inventory part being edited should be applied to. A user is able to select one or none of the repairs.

The following validation can be performed when the screenshot 600 is submitted: Applied Job Code (AJC) may be required; Applied Job Code (AJC) may be a required field. Whatever values are specified here will be the values pre-filled on the handheld when the indicia is scanned to add the repairs. The user on the device (e.g., handheld) can complete the missing values (and modify the other values) for the repairs after scanning the indicia on the device. Each field is validated to ensure it is a valid value for that field (e.g., job code specified is a valid job code, condition code is valid CC, etc.). There may be validation to ensure the condition code or qualifiers specified are valid for the specified job code.

Using a device, repairs can be added based on an indicia. The device can recognize when a part indicia is scanned and automatically guide the user through the process of completing the repairs to be added for that part.

For example, the device, which may be a handheld device, may comprise a user interface with a display screen. The user interface may be configured to support adding repairs to a workflow by scanning indicia. For adding repairs from indicia, the user interface may be configured to display on the display screen various “tabs,” meaning a window can be viewed with one or more tabs on the window, which upon activation (e.g., clicking, touch input, etc.) render a corresponding window on the display screen. The device can employ a tabbed document interface (TDI) or a Tab, wherein the TDI or tab allows multiple documents to be contained within a single window, using tabs as a navigational widget for switching between sets of documents. It is an interface style most commonly associated with web browsers, web applications, text editors, and preference panes. A workflow, a button and a couple of screens can be added to the device to support adding repair by scanning indicia. For instance, there are two ways to initiate the process of adding repairs from indicia: from the “Repairs” tab, scan a barcode; or from the “Tasks” tab, press the “Scan Part Indicia” (or similarly labeled) button. This takes you to a new screen where you can scan indicia, manually enter a indicia or confirm the indicia scanned if already scanned. After scanning indicia, the part number and repairs associated with the indicia will be displayed. Each repair listed will be displayed in regards to some key repair information and whether the repair is valid or not. When the indicia/part number is verified to be the correct indicia and part, the user walks through each repair completing the required information. The user can complete data by manually filling in the data and pressing the “Enter” key to go through all fields. The user can also scan indicia to fill in the repair field information. The indicia would indicate which field to fill in and the value to fill into that field. The user can also update data in a field by manually entering data or scanning appropriate indicia. When all repairs are completed, the user clicks the “Done” button. A confirmation screen is presented. Repairs are added after the user confirms.

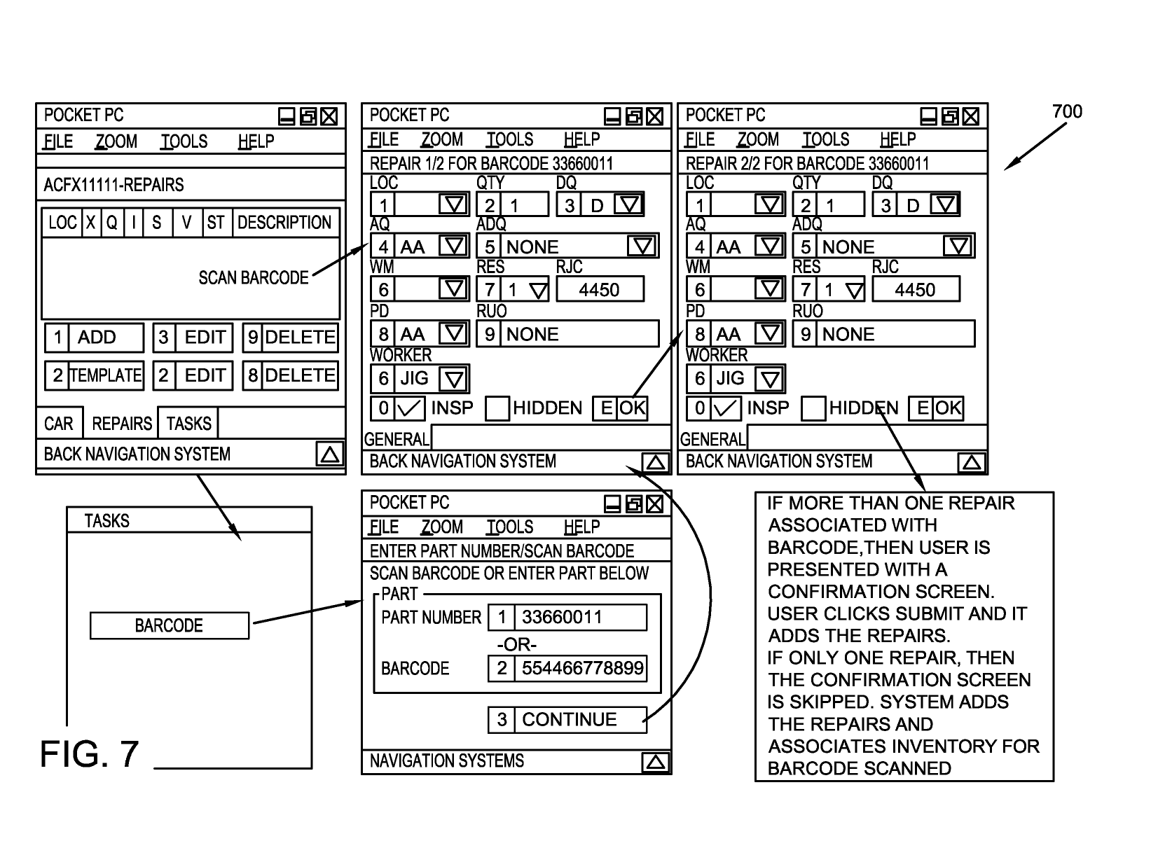

In another embodiment, a workflow 700 illustrated in FIG. 7 can eliminate the screen that lists repairs and would instead display instructions or data to the user directly related to the first repair to complete and would then walk the user through each repair until all repairs are completed. When all repairs are completed, they are added to the data representative of the vehicle (e.g., vehicle data history) along with the inventory that the indicia is on. In an embodiment, the new workflow would be changed to be: (1) Scan a barcode and be presented with first repair associated with indicia OR press an indicia button (or similarly labeled) button on the Tasks tab to scan or manually enter a indicia; (2) Enter and complete information and hit Enter to proceed; (3) If only one repair on indicia, then the sequence can terminate. (4) Repeat Steps (1) and (2) for each repair on barcode; and (5) Press Enter on Confirmation screen to complete process.

Fields can default to a suitable value (e.g., value specified on a web in the “Part Edit” screen, among others). In another embodiment, the device/structure can default the fields to a suitable value. A field left blank can be defaulted when adding to the device. The non-repair field values not specified on the web can be defaulted to the default values for that vehicle (e.g., validation type, price type, etc.). Fields except Applied Job Code (AJC) can be modified by the user after selecting the Edit button. Loc, CC, AQ, AUQ, WM, Resp, RQ and RUQ are drop downs that may only contain values valid for repair in the Edit screen. When the OK button is pressed in the Edit screen, the repair will be validated against AAR and user rules. The user will be prompted if an invalid entry for one of the fields is detected but will be able to continue. The V column will be updated to reflect the validated status of the repairs. A repair can be left in an incomplete or invalid state just as when repairs are added normally on the device.

Some parts may come from a vendor with an indicia already on them. In these situations, that indicia can be configured in for that part and the indicia will be automatically identified and include the data related to the part and sequence for that part. In other words, an indicia for a part may be programmed within the device/system based on a standard historic use. However, many parts come from a vendor without an indicia affixed to them. For these parts, a user can create or print indicia onto labels that can be attached to these parts or to a page of a reference book. When done, the part and repairs can be added by scanning that indicia. A barcode is utilized as an example of an indicia that can be a suitable identifier as described above.

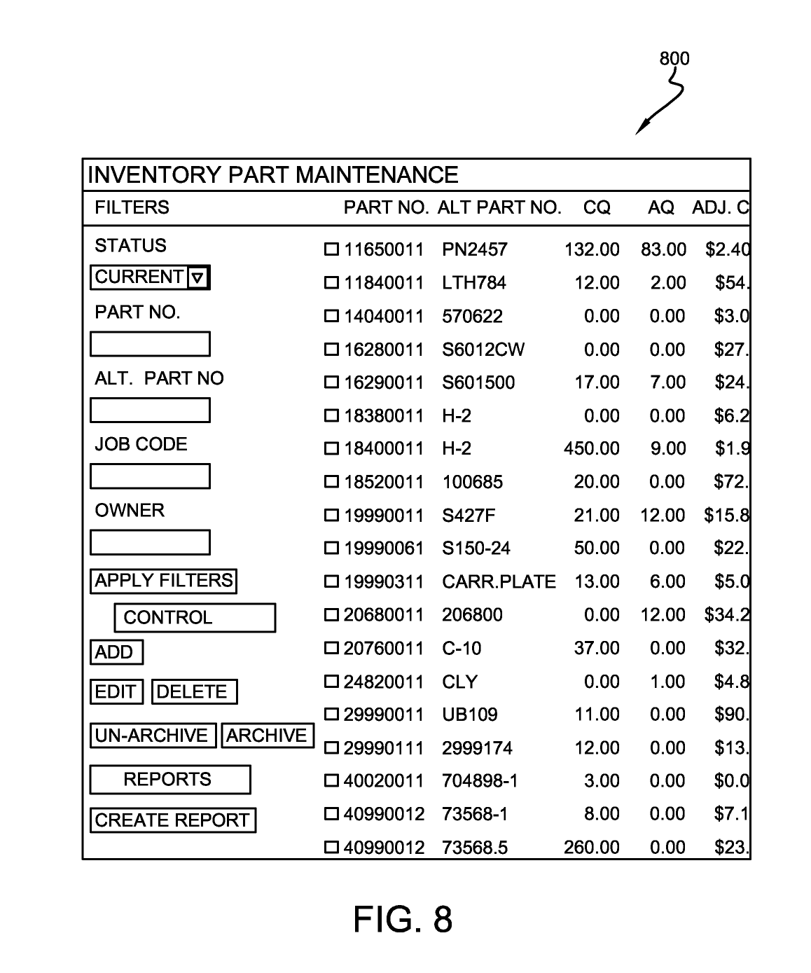

The system can be configured in one or both of two ways of printing barcodes: a new report will be available that will print indicia labels for selected parts or part receipts; or immediately after receiving parts, the corresponding indicia labels for those parts can be printed. Turning to FIG. 8, a screen shot 800 is illustrated. The screenshot 800 illustrates a report generation technique. This report can be generated from the “Inventory Part Maintenance” screen. For example, this screen might be accessible by first selecting a “Settings” option on the user interface, then an “Inventory” option on the user interface, and then a “Parts” option on the user interface. This screen of the user interface may include a section for creating reports, e.g., this section may be accessible by way of a “Control” option on the screen. A user can select one or more parts from the part list and click a “Create Report” button to be directed to the “Input Screen.”

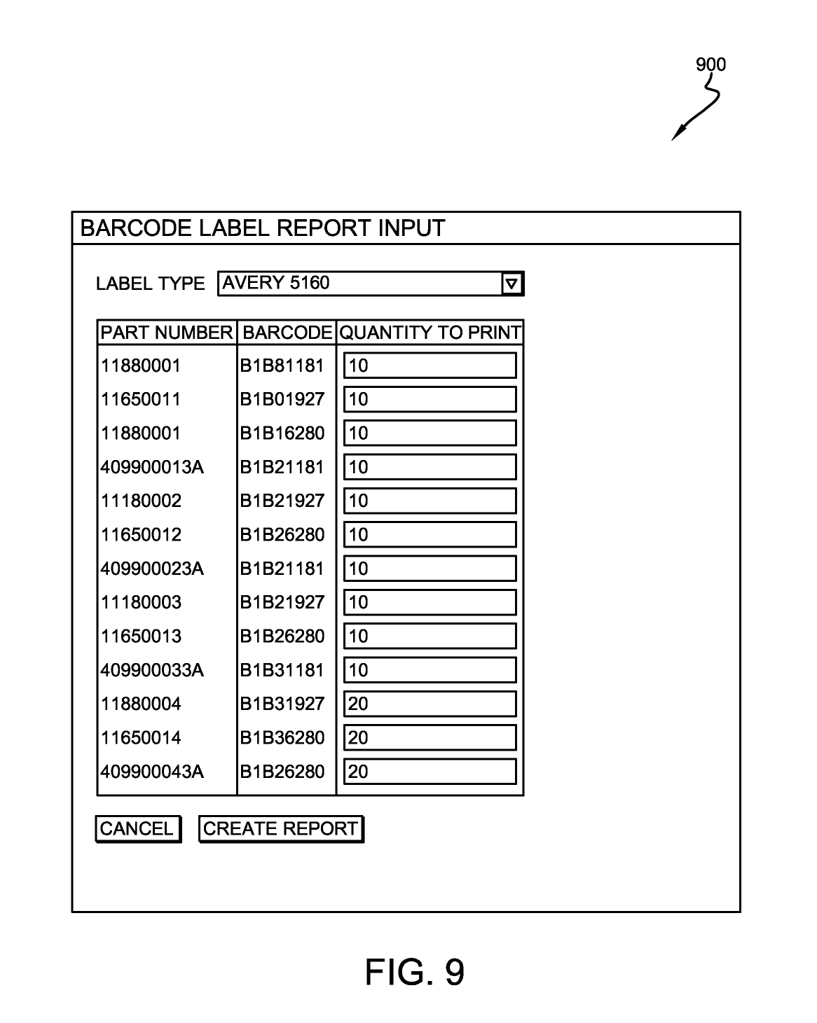

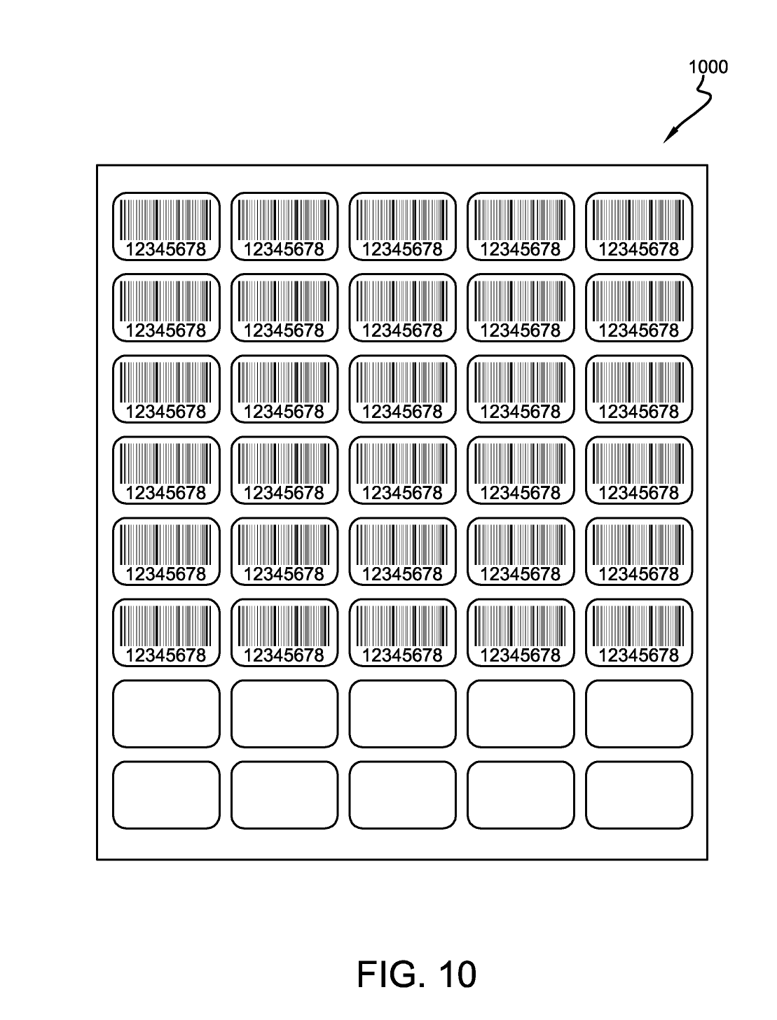

Turning to FIG. 9, a screenshot 900 illustrates a screen for input. This screen can be presented to the user after clicking the Create Report button. It collects details on the labels to be printed. The label type is selected and the number of indicia labels to print for each part is specified. Entering 0 (zero) for a part will cause no indicia labels to print for that part. For instance, the labels will print sequentially from top to bottom with all of indicia being printed before moving on to the next. Turning to FIG. 10, a screenshot 1000 is illustrated of a report.

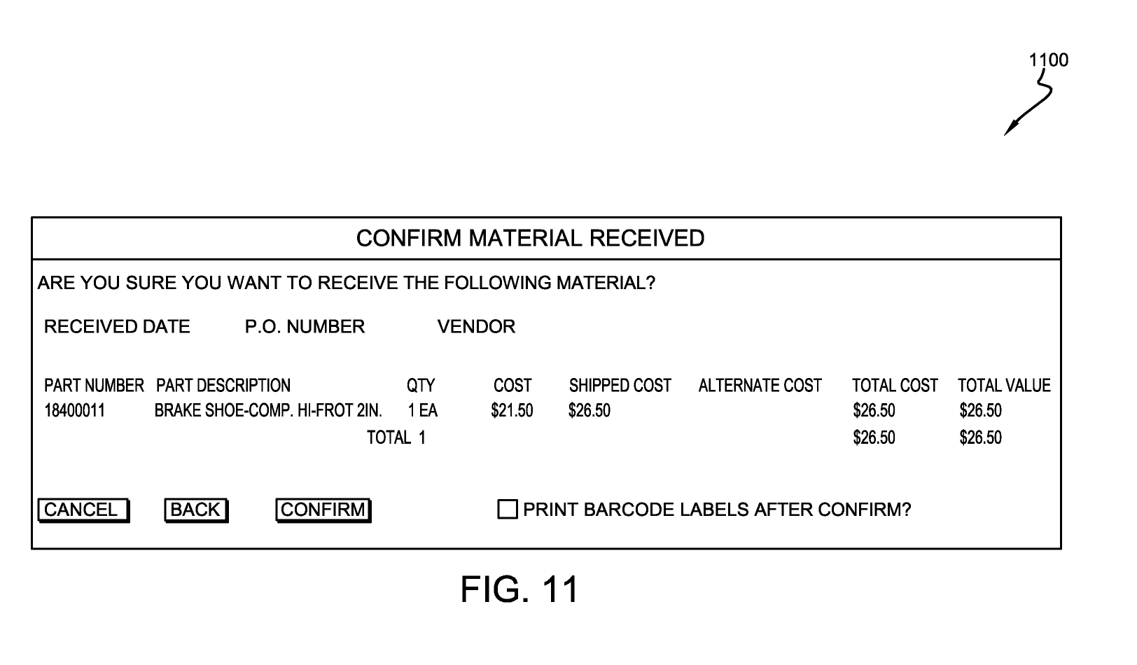

When confirming a material receipt, an option would be given to print indicia labels for the parts received. Such example is illustrated in FIG. 11 with screenshot 1100. If this box is checked, then after clicking “Confirm,” the user would be taken to the “Indicia Label Report Input” screen to specify the label type and number of each indicia label to print. The parts listed and quantities for each part would match the values from the material receipt just performed. The process could be the same as above from there.

By associating indicia with the correct repair data, the system can write up repair bills. By scanning a car or other vehicle into the system and scanning an indicia it will capture the inventory part used and enter the billing repair card (BRC) line item information. Below is a simplified flow: the attached tag will allow inspectors to enter cars on the device by aiming the device at a tag and pulling the trigger; using the built-in device scanner, a user can scan a custom indicia or the indicia supplied by the manufacturer and add the associated billing repair card line item data; and the user can then be prompted to enter a information intentionally left blank in the repair line. For example, the user may be prompted to enter a code that reflects why a part was made, who the part was made for, etc.

The system can provide automated inventory control. If a user enters a repair by scanning indicia, not only does it eliminate chances for error but it also automatically allocates an inventory part in the process beginning the first step in inventory control. Part allocation does not immediately decrement part counts but rather “tells” and communicates to the system that the type of part that is going to be used to complete repairs on that particular vehicle. Inventory managers find this allocation step helpful because when running stock status reports. For instance, a stock status report can indicate 10 parts on in inventory but there are 15 allocated to repairs. In this example, the stock status report can be evaluated and it can be determined that 5 more parts are to be ordered for inventory to complete the repairs.

The system decreases repair entry time. Instead of entering all nine fields to enter a proper billing repair card line item (quantity, location, condition code, qualifiers, etc.) and have the system determine the correct material to use, the material can be used because it is tracked in real time and allocated to a repair upon scanning. The system can allow users to quickly scan an indicia on an inventory part which will add the corresponding repair information. Then, the user can be prompted for remaining information.

The system can eliminate billing errors and/or mistakes. The more information that an employee has to enter, the more room there is for error. Mistakes can happen for many reasons. For example, the employee may not know what information to enter (and may guess at what information to input), or the employee may overlook something. The system automates entering billing codes and repair codes so errors can be mitigated.

In embodiments, repair codes as generated herein are used as the basis for repairing parts and/or vehicles or other client assets. Thus, for the repair, the part or vehicle or other client asset is transformed from a first, pre-repair physical state to a different, second, post-repair physical state, based at least in part on the repair codes as generated. The transformation may be carried out automatically by repair machines, semi-automatically (partially by automatic machines and partially manually), or otherwise.

In an embodiment, a system can be provided that includes at least one of the following: means for linking a part with a repair code from a Car Repair Billing (e.g., link component, among others); means for identifying an indicia for the part (e.g., manual entry via the device, a scanning from the device, identify component, among others); means for identifying the repair code for the part based upon the indicia (e.g., identify component, car repair billing, among others); and means for utilizing the repair code to update at least one of an inventory or an invoice (e.g., inventory component, invoice component, among others).

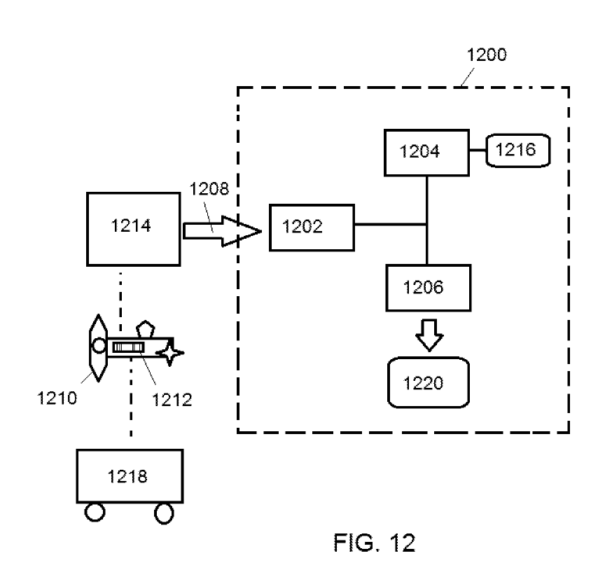

In another embodiment, with reference to FIG. 12, a system 1200 comprises a communication module 1202, a scheduling module 1204 operably coupled with the communication module, and a billing module 1206 operably coupled with the scheduling module. For example, the modules 1202, 1204, 1206 may be hardware and/or software modules (e.g., one or more controllers or other electronic devices configured for performing one or more designated functions, and/or instructions, stored in a non-transient medium and readable by the devices, which when executed by the devices cause the devices to carry out one or more functions as specified according to the content of the instructions), and may be integrated into a single unit (e.g., into a single computer or other controller-based device) or distributed among two or more separate units. The communication module 1202 is configured to receive information 1208 relating to a first part 1210. The information is generated at least in part from at least one of a scan or a read of an indicia 1212 associated with the first part. (For example, the indicia may be scanned and/or read by a device 1214, such as a handheld device, that has an input for receiving signals responsive to reading or scanning the indicia. An example is a bar code reader. Another example is a camera or other optical input for receiving visible or other light reflected off the indicia.) The scheduling module 1204 is configured to automatically schedule 1216 (e.g., generate a schedule), based on the information 1208, one or more of: delivery of a replacement part to replace the first part; one or more actions relating to a repair of the first part or a repair of a vehicle 1218 associated with the first part; or training relating to at least one of the first part, repair of the first part, or repair of the vehicle. The billing module 1206 is configured to automatically generate, based on at least one of the information 1208 or the schedule 1216, billing data 1220 for at least one of the first part, the replacement part, the repair of the first part, the repair of the vehicle, or the training.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A method, comprising:
establishing an association between a first part and an indicia; and
generating at least one repair code for the first part based at least on the association.

2. The method of claim 1, further comprising establishing a second association between the indicia, the first part and a vehicle.

3. The method of claim 1, wherein the indicia is associated with a plurality of parts such that the repair code is generated based on at least one of a read or a scan of any one of the plurality of parts, and wherein the plurality of parts includes the first part.

4. The method of claim 3, further comprising:
receiving a repair order at a repair facility;
identifying the indicia for at least one of the plurality of parts for the repair order based on at least one of a scanning or a reading of the indicia; and
closing the repair order upon the identification of said at least one of the plurality of parts for the repair order.

5. The method of claim 3, further comprising:
repairing at least one of the plurality of parts associated with the repair code in response to at least one of a read or a scan of the indicia; or
replacing at least one of the plurality of parts associated with the repair code in response to at least one of a read or a scan of the indicia.

6. The method of claim 1, wherein the repair code is one of a plurality of repair codes, and each of the plurality of repair codes is associated with a single repair or a defined set of discrete repairs.

7. The method of claim 1, further comprising linking the first part to the repair code, wherein the repair code represents a repair for a vehicle.

8. The method of claim 7, wherein the repair code corresponds to a Car Repair Billing.

9. The method of claim 1, wherein the indicia is a barcode.

10. The method of claim 1, wherein the indicia is an unpowered near field communication tag or a radio-frequency identification chip.

11. The method of claim 1, further comprising updating an inventory for the part based upon an identification of the part.

12. The method of claim 1, further comprising generating a purchase order for the part to increase an inventory.

13. The method of claim 1, wherein the step of generating the at least one repair code comprises generating plural repair codes for the first part based at least on the association.

14. The method of claim 1, wherein the generating and establishing steps are carried out by a handheld device.

15. The method of claim 14, wherein the handheld device provides at least one of the following:
associating the indicia to the first part for the vehicle;
linking the first part to the repair that represents a maintenance for the vehicle;
identifying the first part based on the indicia; and
generating the repair code for the first part based upon the identifying.

16. A system, comprising:
a first component configured to create an indicia for a part;
a second component configured to link the part with a repair code from a Car Repair Billing;
a device configured to identify the indicia for the part; and
a third component configured to identify the repair code for the part based upon the indicia.

17. The system of claim 16, wherein the indicia is at least one of a barcode, a near field communication tag, or a radio-frequency identification tag.

18. The system of claim 16, wherein the indicia is at least one of a model number of the part, a serial number of the part, or an existing barcode for the part.

19. The system of claim 16, further comprising a fourth component configured to update an inventory for the part based upon the identification of the indicia for the part.

20. The system of claim 19, wherein the fourth component is further configured to generate a purchase order to increase the inventory for the part.

21. The system of claim 20, further comprising a fifth component configured to generate an invoice for a repair that includes the repair code.

22. A system, comprising:
means for linking a part with a repair code from a Car Repair Billing;
means for identifying an indicia for the part;
means for identifying the repair code for the part based upon the indicia; and
means for utilizing the repair code to update at least one of an inventory or an invoice.

23. The system of claim 22, wherein:
the means for identifying the indicia comprises a device for reading at least one of a barcode, a NFC tag, or an RFID tag; and
the means for linking the part with a repair code from a Car Repair Billing comprises a programmed processor system, for identifying the repair code for the part based upon the indicia, and the means for utilizing the repair code to update at least one of an inventory or an invoice comprises a networked electronic processing system.

24. A system, comprising:
a communication module configured to receive information relating to a first part, wherein the information is generated at least in part from at least one of a scan or a read of an indicia associated with the first part;
a scheduling module operably coupled with the communication module and configured to automatically schedule, based on the information, one or more of:
delivery of a replacement part to replace the first part; one or more actions relating to a repair of the first part or a repair of a vehicle associated with the first part; or
training relating to at least one of the first part, repair of the first part, or repair of the vehicle; and
a billing module operably coupled with the scheduling module and configured to automatically generate, based on at least one of the information or the schedule, billing data for at least one of the first part, the replacement part, the repair of the first part, the repair of the vehicle, or the training.
